(19) United States
(12) Patent Application Publication
(10) Pub. No.: US 2002/0142753 A1
(43) Pub. Date: Oct. 3, 2002

(54) Method and apparatus for anonymous network access in the absence of a mobile subscriber identity module

(76) Inventors: Mark E. Pecen, Palatine, IL (US); Niels Peter Skov Andersen, Roskilde (DK); Stephen Andrew Howell, Gloucester (GB)

Correspondence Address: MOTOROLA INC, 600 NORTH US HIGHWAY 45, LIBERTYVILLE, IL, 60048-5343, US

(21) Appl. No.: 09/884,781

(22) Filed: Jun. 19, 2001

Related U.S. Application Data
(63) Continuation-in-part of application No. 09/824,346, filed on Apr. 2, 2001.

(51) Int. Cl. H04M 1/66

(52) U.S. Cl. 455/411; 455/404; 455/466

(57) ABSTRACT

A method and apparatus enabling a mobile user device (102) to anonymously access a network (108, 114) in circumstances where access to the network is prohibited that includes an interim identity generator (138), positioned in the mobile user device, generating an interim international mobile subscriber identity (IMSI) in response to access to the network being prohibited. The interim IMSI is utilized for signaling exchanges requiring information corresponding to a SIM card (142) when access is prohibited. A user identity module (152, 154) detects the presence of the interim IMSI in a signaling message, and routes the signaling message to a first home location register (156), in response to the signaling message including the interim IMSI, which then computes and transmits an authentication triplet to the mobile user device. The user identity module routes the signaling message to a second home location register (150) in response to the signaling message not including the interim IMSI.

### RELATIONSHIP TO CO-PENDING APPLICATION

This is a continuation-in-part of prior U.S. application Ser. No. 09/824,346, filed Apr. 2, 2001, which is incorporated herein by reference, and priority thereto for common subject matter is hereby claimed.

### FIELD OF THE INVENTION

The present invention relates generally to wireless communications, and in particular, the present invention relates to generation of anonymous voice and data transmission by a wireless mobile user device in the absence of a subscriber identity module.

### BACKGROUND OF THE INVENTION

In a Global System for Mobile Communications (GSM) system and in other telecommunications systems, a mobile device includes hardware and software specific to a radio interface, along with subscriber specific data located in a subscriber identity module, or “SIM”. The SIM can either be a smart card having physical dimensions similar to the well-known size of credit cards, or alternately can be “cut” to a much smaller format, commonly referred to as a “plug-in SIM”. In either case, the SIM card contains and organizes information, such as identity information identifying the subscriber as a valid subscriber, subscriber supplied information, such as telephone numbers, for example, operator specific information, and a certain subset of mobility management state information, such as information about the last public land mobile network in which the mobile device was registered.

In particular, an International Mobile Subscriber Identity (IMSI) is contained on the SIM card and includes a mobile country code (MCC), and a mobile network code (MNC), along with pseudorandom digits that are utilized to identify a mobile subscriber upon insertion of the SIM card within the mobile user device. In this way, when inserted within a mobile user device in a cellular network, the SIM card enables the mobile user device to be personalized, or associated with subscriber specific information, and allows network signaling to be performed between the mobile user device and the network.

Current GSM specifications, GSM 04.08, “Digital Cellular Telecommunications System (Phase 2+); Mobile Radio Interface Layer 3Specification”, (European Telecommunications Standards Institute (ETSI); European Standard (Telecommunications series)), GSM 04.18, Digital Cellular Telecommunications System (Phase 2+); Mobile Radio Interface Layer 3Specification, Radio Resource Control Protocol”, (European Telecommunications Standards Institute (ETSI); European Standard (Telecommunications series)), along with the third generation technical specification, 3GPP 24.008, “3^{rd} Generation Partnership Project; Technical Specification Group Core Network; Mobile Radio Interface Layer 3Specification; Core Network Protocols-Stage 3”,(3^{rd} Generation Partnership Project (3GPP); Technical Specification (TS)) set forth the means for allowing a mobile subscriber to place an emergency voice call without having a subscriber identity module installed in the mobile device. However, there is currently no means available to a mobile subscriber, either on GSM General Packet Radio Service (GPRS) or on Universal Mobile Telephone Service (UMTS), which is a third generation wireless network standard enhancing GSM, to place an anonymous call, such as an emergency call, in either a circuit-switched or a packet-switched data domain without a SIM card.

Accordingly, what is needed is a method and apparatus for enabling the generation of anonymous network access in the absence of a subscriber identity module in a circuit-switched and a packet-switched data domain.

### BRIEF DESCRIPTION OF THE DRAWINGS

The features of the present invention which are believed to be novel are set forth with particularity in the appended claims. The invention, together with further objects and advantages thereof, may best be understood by making reference to the following description, taken in conjunction with the accompanying drawings, in the several figures of which like reference numerals identify like elements, and wherein:

FIG. 1 is a schematic diagram of a wireless communication system according to the present invention.

FIG. 2 is a schematic diagram of a generated interim International Mobile Subscriber Identity (IMSI) according to the present invention.

FIG. 3 is a data flow diagram for an anonymous network access according to the present invention.

### DETAILED DESCRIPTION OF THE PREFERRED EMBODIMENT

The present invention is a method and apparatus enabling a mobile user device to anonymously access one or more networks in circumstances where access would otherwise be prohibited, and that has minimal impact on the existing standardized signaling protocol and accommodates calls within both the circuit-switched voice and packet-switched data domains. For example, the present invention enables access to one or more networks in the absence of a subscriber identity module (SIM) card within the mobile user device, or in the event that the user or subscriber has been barred from service, such as when, for example, the user attempts to utilize a pre-pay SIM that has no credit or money remaining on the SIM account, when the user's account with the subscriber service has expired or has been barred for non-payment of prior bills, or when the user is in an area in which no roaming agreement applies, and so forth.

An interim international mobile subscriber identity (IMSI) is generated in response to access by the mobile user device being prohibited so that the interim IMSI is utilized for signaling exchanges requiring information corresponding to the SIM card when the SIM card is not inserted within the mobile user device or when service is barred, for example. A user identity module detects the presence of the interim IMSI in a signaling message, and routes the signaling message to a first home location register, in response to the signaling message including the interim IMSI, which then computes and transmits an authentication triplet to the mobile user device. The user identity module routes the signaling message to a second home location register in response to the signaling message not including the interim IMSI.

The interim IMSI conforms to known length characteristics of an IMSI used when the SIM card is inserted within the mobile user device, and includes a predetermined unused interim mobile country code, a predetermined unused interim mobile network code, and pseudo-random digits associated containing a portion of an international mobile equipment identity (IMEI) associated with the mobile user device. The interim IMSI is generated using one or more of local information containing an international mobile equipment identity (IMEI) corresponding to the mobile user device, local information containing a pre-computed SRES, local information containing a pre-computed ciphering key, a combination of identities that reside on the SIM card, and portions of identities that reside on the SIM card.

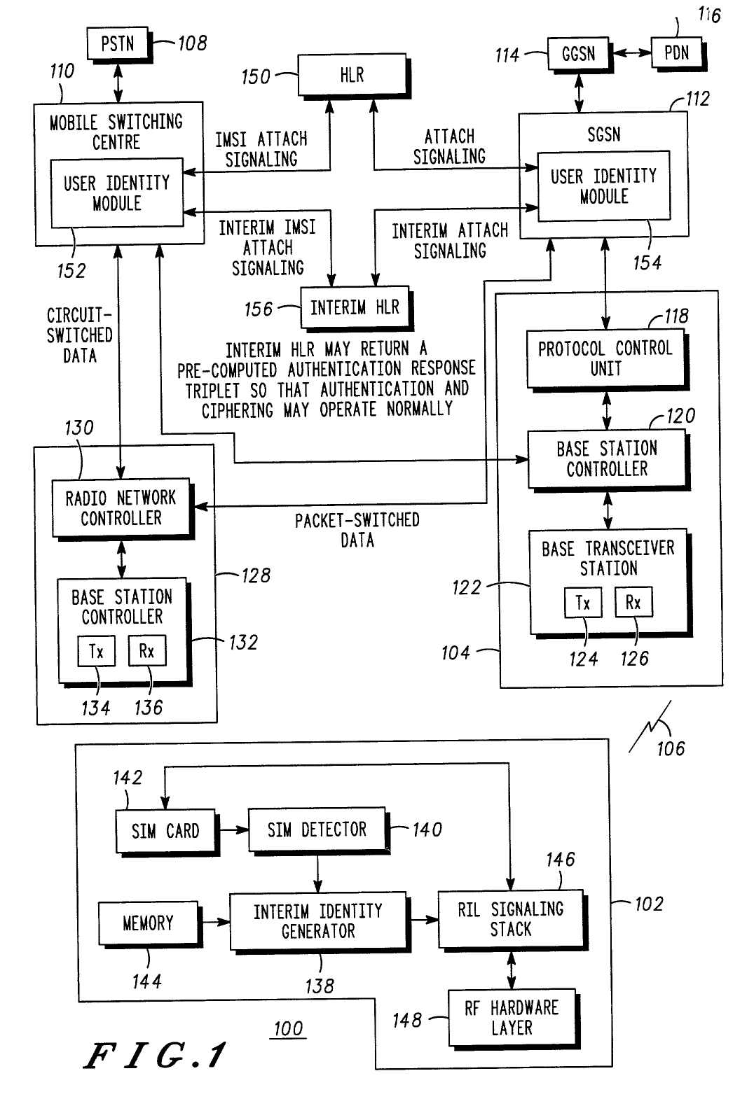

FIG. 1 is a schematic diagram of a wireless communication system according to the present invention. As illustrated in FIG. 1, a wireless communication system 100 according to the present invention includes a mobile user device 102, such as a wireless telephone device, capable of either second generation Global System for Mobile Communications (GSM) data interchange or third generation Universal Mobile Telephone System (UMTS) data interchange, or both. For example, mobile user device 102 transmits circuit-switched data through an air interface 106 to, and receives circuit-switched data through air interface 106 from a second generation GSM General Packet Radio Service (GPRS) and Enhanced Data for Global Evolution (EDGE), GSM GPRS/EDGE radio access network 104. The circuit-switched data is transmitted by radio access network 104 from mobile user device 102 to a public switched telephone network (PSTN) 108, and from public switched telephone network 108 to mobile user device 102, through a mobile switching center 110.

Mobile user device 102 transmits packet-switched data through air interface 106 to, and receives packet-switched data through air interface 106 from radio access network 104. The packet-switched data received from mobile user device 102 is transmitted by radio access network 104 to a serving GPRS support node 112, which then transmits the packet-switched data to a gateway GPRS support node (GGSN) 114. Gateway GPRS support node 114 converts the packet-switched data from a domain associated with radio access network 104 to a domain associated with a packet data network 116 and transmits the converted packet-switched data to packet data network 116.

Similarly, packet-switched data received from packet data network 116 is converted by gateway GPRS support node 114 from the domain associated with packet data network 116 to the domain associated with radio access network 104. The converted packet-switched data is then transmitted from gateway GPRS support node 114 to radio access network 104 through GPRS support node 112. Radio access network 104 then transmits the packet-switched data to mobile user device 102 along interface 106.

Radio access network 104 includes a protocol control unit 118 that interfaces between serving GPRS support node 112 and a base station controller 120, which controls the packet-switched data that is transmitted between packet data network 116 and mobile user device 102. Base station controller 120 controls one or more base transceiver stations, including a base transceiver station 122 located in radio access network 104. Base transceiver station 122 includes a transmitter 124 and a receiver 126 for transmitting and receiving data between mobile user device 102 and radio access network 104 along interface 106. Base station controller 120 transmits packet-switched data received from packet data network 116 via protocol control unit 118 to base transceiver station 122, which then transmits the packet-switched data to mobile user device 102 along air interface 106. In the same way, base station controller 120 transmits packet-switched data received from mobile user device 102 via base transceiver station 122 to protocol control unit 118. The packet-switched data is then transmitted from protocol control unit 118 to packet data network 116 through serving GPRS support node 112 and gateway GPRS support node 114.

In addition to receiving packet-switched data exchanged between packet data network 116 and mobile user device 102, base station controller 120 receives circuit-switched data transmitted from public switched telephone network 108 to mobile user device 102 through mobile switching center 110, and transmits the circuit switched data to base transceiver station 122. The circuit-switched data is then transmitted from base transceiver station 122 to mobile user device 102 along air interface 106.

Base transceiver station 122 transmits circuit-switched data received from mobile user device 102 for transmission to public switched telephone network 108 to base station controller 120, and the circuit-switched data is then transmitted from base station controller 120 to mobile switching center 110, which then transmits the circuit-switched data to public switch telephone network 108.

In this way, according to a first embodiment of the present invention, wireless communication system 100 includes mobile user device 102, radio access network 104 and mobile switching center 110, with mobile user device 102 being capable of transmitting and receiving circuit-switched data along a circuit-switched data path between mobile user device 102 and public switched telephone network 108 through mobile switching center 110, radio access network 104 and air interface 106. According to a second embodiment of the present invention, wireless communication system 100 includes mobile user device 102, radio access network 104, serving GPRS support node 112 and gateway GPRS support node 114, with mobile user device 102 being capable of transmitting and receiving packet-switched data along a packet-switched data path between mobile user device 102 and packet data network 116 through gateway GPRS support node 114, serving GPRS support node 112, radio access network 104 and air interface 106.

According to a third embodiment of the present invention, wireless communication system 100 includes mobile user device 102, radio access network 104, mobile switching center 110, serving GPRS support node 112 and gateway GPRS support node 114. As a result, according to the third embodiment of the present invention, mobile user device 102 is capable of transmitting and receiving circuit-switched data along a circuit-switched data path between mobile user device 102 and public switched telephone network 108, through mobile switching center 110 and radio access network 104. In addition, mobile user device 102 is also capable of transmitting and receiving packet-switched data along a packet-switched path between mobile user device 102 and packet data network 116 through gateway GPRS support node 114, serving GPRS support node 112, radio access network 104 and air interface 106.

As illustrated in FIG. 1, according to the present invention, mobile user device 102 transmits circuit-switched data through air interface 106 to, and receives circuit-switched data through air interface 106 from a third generation UMTS radio access network 128. Circuit-switched data received from mobile user device 102 is transmitted by radio access network 128 to public switched telephone network 108 through mobile switching center 110, and circuit-switched data received from public switched telephone network 108 through mobile switching center 110 is transmitted by radio access network 128 to mobile user device 102. Mobile user device 102 transmits packet-switched data through air interface 106 to, and receives packet-switched data through air interface 106 from radio access network 128. The packet-switched data received by radio access network 128 from mobile user device 102 is transmitted by radio access network 128 to serving GPRS support node 112, which then transmits the packet-switched data to gateway GPRS support node (GGSN) 114. Gateway GPRS support node 114 converts the packet-switched data from a domain associated with radio access network 128 to a domain associated with packet data network 116 and transmits the converted packet-switched data to packet data network 116.

Similarly, packet-switched data received from packet data network 116 is converted by gateway GPRS support node 114 from the domain associated with packet data network 116 to the domain associated with radio access network 104. The converted packet-switched data is then transmitted from gateway GPRS support node 114 to radio access network 128 through GPRS support node 112. Radio access network 128 then transmits the packet-switched data to mobile user device 102 along interface 106.

Radio access network 128 includes a radio network controller 130 that is capable of discerning between the packet-switched data domain and the circuit-switched data domain to enable interface between radio access network 128 and both packet data network 116 and public switched telephone network 108. As a result, radio access network 128 interfaces with serving GPRS support node 112 and mobile switching center 110, with radio network controller 130 controlling packet-switched data that is transmitted between packet data network 116 and mobile user device 102 and circuit-switched data that is transmitted between public switched telephone network 108 and mobile user device 102.

In particular, radio network controller 130 interfaces with a base station controller 132 located in radio access network 128 that includes a transmitter 134 and a receiver 136 for transmitting and receiving data transmitted between mobile user device 102 and radio access network 128 along interface 106. Radio network controller 130 transmits packet-switched data received from packet data network 116, through serving GPRS support node 112 and gateway GPRS support node 114, to base station controller 132, which then transmits the packet-switched data to mobile user device 102 along air interface 106. Radio network controller 130 transmits packet-switched data received from mobile user device 102 via base station controller 132 to packet data network 116 through serving GPRS support node 112 and gateway GPRS support node 114. In the same way, radio network controller 130 transmits circuit-switched data received from public switched telephone network 108, through mobile switching center 110, to base station controller 132, which then transmits the circuit-switched data to mobile user device 102 along air interface 106. Finally, radio network controller 130 transmits circuit-switched data received from mobile user device 102 via base station controller 132 to public switched telephone network 108 through mobile switching center 110.

In this way, according to a fourth embodiment of the present invention, wireless communication system 100 includes mobile user device 102, radio access network 128 and mobile switching center 110, with mobile user device 102 being capable of transmitting and receiving circuit-switched data along a circuit-switched data path between mobile user device 102 and public switched telephone network 108 through mobile switching center 110, radio access network 128 and air interface 106. According to a fifth embodiment of the present invention, wireless communication system 100 includes mobile user device 102, radio access network 128, serving GPRS support node 112 and gateway GPRS support node 114, with mobile user device 102 being capable of transmitting and receiving packet-switched data along a packet-switched data path between mobile user device 102 and packet data network 116 through gateway GPRS support node 114, serving GPRS support node 112, radio access network 128 and air interface 106.

According to a sixth embodiment of the present invention, wireless communication system 100 includes mobile user device 102, radio access network 128, mobile switching center 110, serving GPRS support node 112 and gateway GPRS support node 114. As a result, according to the sixth embodiment of the present invention, mobile user device 102 is capable of transmitting and receiving circuit-switched data along a circuit-switched data path between mobile user device 102 and public switched telephone network 108, through mobile switching center 110 and radio access network 128, and is also capable of transmitting and receiving packet-switched data along a packet-switched path between mobile user device 102 and packet data network 116 through gateway GPRS support node 114, serving GPRS support node 112, radio access network 128 and air interface 106.

Finally, according to a seventh embodiment of the present invention, mobile communications system 100 includes mobile user device 102, radio access networks 104 and 128, mobile switching center 110, serving GPRS support node 112 and gateway GPRS support node 114. According to the seventh embodiment of the present invention, mobile user device 102 is capable of transmitting and receiving circuit-switched data along a circuit-switched data path between mobile user device 102 and public switched telephone network 108, through mobile switching center 110 and radio access network 104. In addition, mobile user device 102 is also capable of transmitting and receiving packet-switched data along a packet-switched path between mobile user device 102 and packet data network 116 through gateway GPRS support node 114, serving GPRS support node 112, radio access network 104 and air interface 106. Furthermore, according to the seventh embodiment of the present invention, mobile user device 102 is capable of transmitting and receiving circuit-switched data along a circuit-switched data path between mobile user device 102 and public switched telephone network 108, through mobile switching center 110 and radio access network 128. Finally, mobile user device 102 is also capable of transmitting and receiving packet-switched data along a packet-switched path between mobile user device 102 and packet data network 116 through gateway GPRS support node 114, serving GPRS support node 112, radio access network 128 and air interface 106.

As a result, the present invention provides a multiple air interface, corresponding to the seven embodiments described above, that enables anonymous network access by mobile user device 102 along either the circuit-switched path or the packet-switched path from mobile user device 102 to public switched telephone network 108 and packet data network 116, respectively, or both, and through either second generation GSM GPRS/EDGE radio access network 104 or third generation UMTS radio access network 128, or both, using the anonymous access of the present invention, as will be described below.

In particular, according to the present invention and as illustrated in FIG. 1, mobile user device 102 includes an interim identity generator 138 for generating an interim International Mobile Subscriber Identity (IMSI), a SIM detector 140 for detecting the presence of a SIM card 142 within mobile user device 102, and a memory 144 for storing local information, such as local information containing an international mobile equipment identity (IMEI) corresponding to mobile user device 102, local information containing a pre-computed SRES, local information containing a pre-computed ciphering key, or any other combination of identities or portions of identities that may reside on an actual SIM or UIM utilized by interim identity generator 138, as described below.

SIN detector 140 detects the presence of SIM card 142 within mobile user device 102, and informs interim identity generator 138 when SIM card 142 is not positioned within mobile user device 102. In addition, SIN detector 140 also detects when the user or subscriber has been barred from service, such as, for example, when the user attempts to utilize a pre-pay SIM that has no credit or money remaining on the SIM account, when the user's account with the subscriber service has expired or has been barred for non-payment of prior bills, or when the user is in an area in which no roaming agreement applies, and so forth.

As a result, according to the present invention, when access to the network is prohibited, interim identity generator 138 generates an interim International Mobile Subscriber Identity (IMSI), which is then available to a radio interface layer signaling stack 146 of mobile user device in the absence of SIM card 142 or in the event service is barred. This generated interim IMSI would then be used to perform an anonymous IMSI attach procedure in the circuit-switched domain or an anonymous GPRS attach procedure in the packet-switched domain. An operator of radio access networks 104 and 128 would have full control over whether or not to enable the anonymous calling procedure, such as for emergency calling service for example, and which is applicable in countries in which regulators require that SIM card be used for emergency calls. Optionally, mobile user device 102 may be granted a special anonymous GPRS attach of sorts, which would enable mobile user device 102 to receive data calls as well.

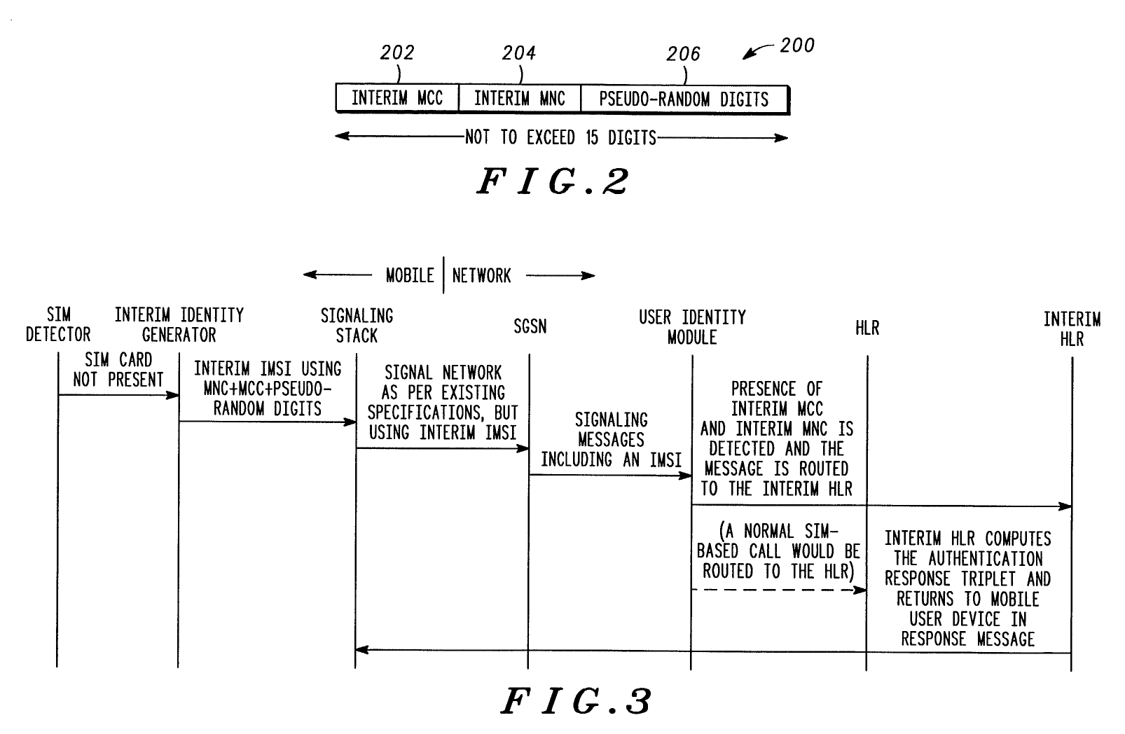

FIG. 2 is a schematic diagram of a generated interim International Mobile Subscriber Identity (IMSI) according to the present invention. In particular, the generated interim IMSI would conform to the length characteristics of a known IMSI as set forth in GSM 04.18,Digital Cellular Telecommunications System (Phase 2+); Mobile Radio Interface Layer 3 Specification, Radio Resource Control Protocol”, (European Telecommunications Standards Institute (ETSI); European Standard (Telecommunications series)), incorporation herein by reference, and is therefore up to 15 digits in length and is encoded as a series of 4-bit quantities. For example, as illustrated in FIG. 2, interim identity generator 138 generates an interim IMSI 200 that includes an interim mobile country code (MCC) 202, and an interim mobile network code (MNC) 204, along with a set of pseudo-random digits 206.

According to the present invention, interim mobile country code 202 and interim mobile network code 204 correspond respectively to a predetermined unused mobile country code and a predetermined unused mobile network code. Pseudo-random digits 206 contain, for example, a portion of the international mobile equipment identity (IMEI) associated with mobile user device 102, as per the third generation technical specification, 3GPP 23.003, “3 ^{rd} Generation Partnership Project; Technical Specification Group Core Network; Numbering, Addressing and Identification”, (3^{rd} Generation Partnership Project (3GPP); Technical Specification (TS)), incorporated herein by reference, and in this manner the call could be traced to an equipment owner.

As illustrated in FIG. 1, if SIM card 142 is inserted within mobile user device 102 and if service is not barred, known IMSI attach signaling is performed between a home location register 150 and SIM card 142. In particular, when circuit-switched data is being transmitted along the circuit-switched data path between mobile user device 102 and public switched telephone network 108 via either one of radio access network 104 and radio access network 128, in the first, third, fourth, sixth and seventh embodiments described above, a user identity module 152 of mobile switching center 110 directs the IMSI attach signaling to one of radio access network 104 and radio access network 128, respectively. When packet-switched data is being transmitted along the packet-switched data path between mobile user device 102 and packet data network 116 via either one of radio access network 104 and radio access network 128, in the second, third, fifth, sixth and seventh embodiments described above, a user identity module 154 of serving GPRS support node 112 directs the IMSI attach signaling to one of radio access network 104 and radio access network 128, respectively.

However, according to the present invention, if SIM card 142 is not inserted within mobile user device 102, SIM detector 140 informs interim identity generator 138 of the absence of SIM card 142, and, in the same way, if there is a barred service condition, SIM detector 140 informs interim identity generator 138 of the barred service condition, and in both cases interim identity generator 138 then generates interim IMSI 200, using the local information stored in memory 144, such as local information containing an international mobile equipment identity (IMEI) corresponding to mobile user device 102, local information containing a pre-computed SRES, local information containing a pre-computed ciphering key, or any other combination of identities or portions of identities that may reside on an actual SIM or UIM.

The IMSI attach/detach procedures set forth in clause 4.4.3 and 4.4.4, and the GPRS attach/detach procedures set forth in clause 4.7.3 and 4.7.4 of the third generation technical specification, 3GPP 24.008, “3^{rd} Generation Partnership Project; Technical Specification Group Core Network; Mobile Radio Interface Layer 3 Specification; Core Network Protocols-Stage 3”, (3^{rd} Generation Partnership Project (3GPP); Technical Specification (TS)), incorporated herein by reference, are then utilized using interim IMSI 200. These attach/detach procedures further enable the mobility management and GPRS mobility management signaling procedures as specified in clause 4 of the third generation technical specification, 3GPP 24.008, “3^{rd}Generation Partnership Project; Technical Specification Group Core Network; Mobile Radio Interface Layer 3 Specification; Core Network Protocols-Stage 3”, (3^{rd}Generation Partnership Project (3GPP); Technical Specification (TS)), incorporated herein by reference.

In particular, as illustrated in FIG. 1, interim IMSI 200 is transmitted to radio access network 104 and 128 along air interface 106 through signaling stack 146 and RF hardware layer 148, and is detected along the circuit-switched path and the packet switched path by one of user identity module 152 and user identity module 154, respectively. For example, once interim MCC 202, interim MNC 204 and pseudorandom digits 206 are detected by user identity module 152 during transmission in the circuit-switched data path, or by user identity module 154 during transmission in the packet-switched data path, user identity modules 152 and 154 route interim IMSI 200 to an interim HLR 156, which then sends the required response to any such signaling message that contains interim MCC 202 and interim MNC 204, and calculates a proper authentication response triplet based on the entire interim IMSI 200, sending the triplet back to mobile user device 102. Mobile user device 102 then proceeds with the normal authentication and ciphering procedures.

FIG. 3 is a data flow diagram for an anonymous network access according to the present invention. As illustrated in FIGS. 1 and 3, when packet-switched data path is used, once SIM detector 140 notifies interim identity generator 138 that SIM card 142 is not present or that service is barred, interim identity generator 138 generates and sends interim IMSI 200, including interim MCC 202, interim MNC 204 and pseudo-random identifier 206 generated using local information stored in memory 144, to signaling stack 146. Signaling stack 146 then uses interim IMSI 200 for any signaling exchanges that require an IMSI during any period in which SIM card 142 is not inserted within mobile user device 102 or service is barred. Mobile user device 102 then signals appropriate radio access networks 104 and 128 as per existing specifications, using interim IMSI 200 in place of IMSI that would be provided if SIM card 142 were inserted within mobile user device 102.

In particular, according to the present invention, upon reception of the resulting signaling at serving GPRS support node 112, serving GPRS support node 112 directs signaling messages that contain an IMSI to user identity module 154. User identity module 154 detects the presence of interim MNC 202 and interim MCC 204 and routes the signaling to interim HLR 156, which then computes and transmits the authentication response triplet to mobile user device 102 through serving GPRS support node 112, corresponding radio access network 104 and 128, and air interface 106. If, on the other hand, SIM card 142 is not detected as not being within mobile user device 102 and if service is not barred, a normal SIM-based call would be routed to HLR 150.

While the data flow of the present invention is shown in FIG. 3 only for the packet-switched data path, it is understood in the data flow in circuit-switched path is similar to data flow in the packet-switched path, with the exception that signaling takes place between radio access networks 104 and 128 and mobile switching center 110, rather than serving GPRS support node 112, so that mobile switching center 110 directs signaling messages that contain an IMSI to user identity module 152, rather than user identity module 154, and interim IMSI 200 is detected by user identity module 152. Therefore illustration of data flow in the circuit-switched data path can be seen in FIG. 1, and has been omitted merely for brevity.

As a result, the present invention enables the origination and possible reception of information via anonymous access by a mobile device, such as emergency voice and data calls for example, by a third generation wireless mobile subscriber in both the circuit-switched voice and packet-switched data domains in circumstances where access would otherwise be prohibited, such as in the absence of a subscriber identity module or in the event that service is barred, for example, while having minimum impact on the mobile device and network equipment, while at the same time offering a fairly wide range of access and service provision control options in both circuit and packet domains.

While a particular embodiment of the present invention has been shown and described, modifications may be made. It is therefore intended in the appended claims to cover all such changes and modifications that fall within the true spirit and scope of the invention.

What is claimed is:

1. A mobile user device capable of anonymously accessing a network, the mobile user device comprising:
a SIM detector detecting whether access to the network is prohibited; and
an interim identity generator generating an interim international mobile subscriber identity (INSI) in response to access to the network being prohibited, wherein the interim IMSI is utilized for signaling exchanges requiring information corresponding to the SIM card when access is prohibited.

2. The mobile user device of claim 1, further comprising:
a first home location register for signaling exchanges utilizing an IMSI accessed from the SIM card; and
a second home location register for signaling exchanges utilizing the interim IMSI.

3. The mobile user device of claim 1, wherein the mobile user device accesses the network along a circuit-switched path.

4. The mobile user device of claim 1, wherein the mobile user device accesses the network along a packet-switched data path.

5. The mobile user device of claim 1, wherein the mobile user device is capable of accessing the network along one or more of a circuit-switched path and a packet-switched path.

6. The mobile user device of claim 1, wherein the interim IMSI has a length of 15 digits and includes a predetermined unused interim mobile country code, a predetermined unused interim mobile network code, and pseudo-random digits associated containing a portion of an international mobile equipment identity (IMEI) associated with the mobile user device.

7. The mobile user device of claim 1, wherein the interim IMSI is generated using local information corresponding to the mobile user device.

8. The mobile user device of claim 1, wherein interim IMSI is generated using one or more of local information containing an international mobile equipment identity (IMEI) corresponding to the mobile user device, local information containing a pre-computed SRES, local information containing a pre-computed ciphering key, a combination of identities that reside on the SIM card, and portions of identities that reside on the SIM card.

9. The mobile user device of claim 1, wherein the interim identity generator generates the IMSI in response to one of the SIM detector detecting a subscriber identity module card not being inserted within the mobile user device and the SIM detector detecting that service is barred.

10. A wireless communication system comprising:
a first network;
a mobile user device exchanging data with the first network;
an interim identity generator, positioned in the mobile user device, generating an interim international mobile subscriber identity (IMSI) in response to access by the mobile user device being prohibited;
a first radio access network positioned along a first data path extending between the mobile user device and the first network, the first radio access network transmitting and receiving data exchanged between the mobile user device and the first network; and
a first user identity module, positioned along the first data path, detecting the presence of the interim IMSI, wherein the interim IMSI is utilized for signaling exchanges requiring information corresponding to a SIM card while access is prohibited.

11. The wireless communication system of claim 10, wherein the interim identity generator generates the IMSI in response to one of the SIM detector detecting the SIM card not being inserted within the mobile user device and the SIM detector detecting that service is barred.

12. The wireless communication system of claim 10, further comprising:
a first home location register for signaling exchanges utilizing an IMSI accessed from the SIM card in response to access by the mobile user device being prohibited; and
a second home location register for signaling exchanges utilizing the interim IMSI, wherein the first user identity module directs the interim IMSI to the second home location register, and wherein the second home location register computes and transmits an authentication response triplet to the mobile user device upon receipt of the interim IMSI.

13. The wireless communication system of claim 10, wherein the first data path is a packet-switched data path.

14. The wireless communication system of claim 10, wherein the first data path is a circuit-switched data path.

15. The wireless communication system of claim 10, further comprising:
a second network; and
a second user identity module positioned along a second data path extending between the mobile user device and the second network, the second user identity module detecting the presence of the interim IMSI.

16. The wireless communication system of claim 15, further comprising:
a first home location register for signaling exchanges utilizing an IMSI accessed from the SIM card in response to access by the mobile user device being prohibited; and
a second home location register for signaling exchanges utilizing the interim IMSI, wherein the first user identity module and the second user identity module direct the interim IMSI to the second home location register, and wherein the second home location register computes and transmits an authentication response triplet to the mobile user device upon receipt of the interim IMSI.

17. The wireless communication system of claim 16, wherein the first data path is a packet-switched data path and the second data path is a circuit-switched data path, and the mobile user device is capable of transmitting data along one of the first data path and the second data path.

18. The wireless communication system of claim 16, wherein the first data path is a packet-switched data path and the second data path is a circuit-switched data path, and the mobile user device is capable of transmitting data along the first data path and the second data path.

19. The wireless communication system of claim 16, further comprising a second radio access network positioned along a third data path extending between the mobile user device and the first network, and along a fourth data path extending between the mobile user device and the second network, wherein the first network is a packet-switched data network and the second network is a circuit-switched data network.

20. The wireless communication system of claim 16, wherein the interim IMSI has a length of 15 digits and includes a predetermined unused interim mobile country code, a predetermined unused interim mobile network code, and pseudo-random digits associated containing a portion of an international mobile equipment identity (IMEI) associated with the mobile user device.

21. The wireless communication system of claim 20, wherein the first data path and the third data path are packet-switched data paths, the second data path and the fourth data path are circuit-switched data paths, and the mobile user device is capable of transmitting data along the packet-switched data path and the circuit-switched data path.

22. The wireless communication system of claim 21, wherein interim IMSI is generated using one or more of local information containing an international mobile equipment identity (IMEI) corresponding to the mobile user device, local information containing a pre-computed SRES, local information containing a pre-computed ciphering key, a combination of identities that reside on the SIM card, and portions of identities that reside on the SIM card.

23. A method of anonymous network access by a mobile user device when network access is prohibited, comprising:
detecting network access being prohibited; and
generating an interim international mobile subscriber identity (IMSI) in response to network access being prohibited.

24. The method of claim 22, wherein the interim IMSI has a length of 15 digits and includes a predetermined unused interim mobile country code, a predetermined unused interim mobile network code, and pseudo-random digits associated containing a portion of an international mobile equipment identity (IMEI) associated with the mobile user device.

25. The method of claim 24, wherein the interim IMSI is generated using one or more of local information containing an international mobile equipment identity (IMEI) corresponding to the mobile user device, local information containing a pre-computed SRES, local information containing a pre-computed ciphering key, a combination of identities that reside on the SIM card, and portions of identities that reside on the SIM card.

26. The method of claim 25, further comprising the steps of:
detecting whether a signaling message includes the interim IMSI;
routing the signaling message to a first home location register in response to the signaling message including the interim IMSI and to a second home location register in response to the signaling message not including the interim IMSI; and
computing and transmitting an authentication response triplet from the first home location register to the mobile user device.

27. The method of claim 23, wherein the step of detecting further comprises detecting one of a subscriber identity module card not being inserted within a mobile user device and detecting that service is barred.
